(19) United States
(12) Patent Application Publication
(10) Pub. No.: US 2020/0406098 A1
(43) Pub. Date: Dec. 31, 2020

(54) TECHNIQUES FOR GOLF SWING MEASUREMENT AND OPTIMIZATION

(71) Applicant: Medalist Inc., Lakeville, MN (US)

(72) Inventors: John Christopher Bartholomew, Hopkins, MN (US); James Robert Cikanek, Lakeville, MN (US)

(73) Assignee: Medalist Inc., Lakeville, MN (US)

(21) Appl. No.: 16/912,789

(22) Filed: Jun. 26, 2020

Related U.S. Application Data
(60) Provisional application No. 62/867,182, filed on Jun. 26, 2019.

(51) Int. Cl. A63B 24/00; A63B 69/36; A63B 71/06; G06N 5/04; G06N 20/00

(52) U.S. Cl. CPC A63B 24/0006; A63B 69/3623; A63B 71/0622; G06N 5/04; G06N 20/00; A63B 2071/0647; A63B 2024/0009; A63B 2220/62; A63B 2220/807; A63B 2220/89; A63B 2220/806; A63B 2024/0015; A63B 2220/05

(57) ABSTRACT

The techniques described herein relate to methods, apparatus, and computer readable media configured to receive preference data indicative of a user's desired golf ball flight, capture and process time series data of the user while performing a golf swing to generate a time series array of positional values of aspects of the user and/or golf club, process the time series array using a machine learning model to determine data indicative of a predicted ball flight for the captured golf swing, generate data indicative of one or more modifications to the user's golf swing to achieve the desired ball flight instead of the predicted ball flight, generate data indicative of a recommended golf swing for the user to achieve the desired golf ball flight, and generate display data indicative of the recommended golf swing overlaid on second captured time series data of the user.

### RELATED APPLICATIONS

This application claims priority under 35 U.S.C. § 119(e) to U.S. Provisional Application Ser. No. 62/867,182, entitled “TECHNIQUES FOR GOLF SWING MEASUREMENT AND OPTIMIZATION,” filed Jun. 26, 2019, under Attorney Docket No. M1509.70000US00, which is herein incorporated by reference in its entirety.

### BACKGROUND

Golfers often desire to have a consistent and predictable swing. To learn how to golf and/or to work on one's swing, golfers often take lessons with an instructor or learn through trial-and-error on their own (e.g., on the golf course and/or at a driving range). However, golf lessons are expensive and can be inconvenient, which can make lessons impractical. Further, instructors can vary in their ability to analyze a swing and teach proper swing techniques, which can create mixed results for students. Similarly, the success that an individual can achieve when self-training can be highly dependent on their own ability to diagnose their own technique and implement improvements, which can also result in mixed results. Regardless of how a user practices their swing, improvement requires properly diagnosing swing behavior and having the golfer know what to change in order to improve their swing.

### SUMMARY OF INVENTION

In accordance with the disclosed subject matter, apparatus, systems, and methods are provided for receiving preference data indicative of a user's desired golf ball flight, capturing time series data of the user while performing a golf swing, processing the time series data to generate a time series array of positional values of one or more aspects of the golfer, aspects of the golf club, or both, processing the time series array using a machine learning model to determine data indicative of a predicted ball flight for the captured golf swing, generating, based on the time series array and the data indicative of the predicted ball flight, data indicative of one or more modifications to the user's golf swing to achieve the desired ball flight instead of the predicted ball flight, generating, based on the data indicative of one or more modifications to the user's golf swing, data indicative of a recommended golf swing for the user to achieve the desired golf ball flight, and displaying, on a display, data indicative of the recommended golf swing overlaid on second captured time series data of the user performing a second golf swing.

There has thus been outlined, rather broadly, the features of the disclosed subject matter in order that the detailed description thereof that follows may be better understood, and in order that the present contribution to the art may be better appreciated. There are, of course, additional features of the disclosed subject matter that will be described hereinafter and which will form the subject matter of the claims appended hereto. It is to be understood that the phraseology and terminology employed herein are for the purpose of description and should not be regarded as limiting.

### BRIEF DESCRIPTION OF THE DRAWINGS

Various aspects of at least one embodiment are discussed herein with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. Where technical features in the figures, detailed description or any claim are followed by reference signs, the reference signs have been included for the sole purpose of increasing the intelligibility of the figures, detailed description, and/or claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure.

In the figures:

FIG. 1 shows diagrams of side equipment and rear equipment of a golf swing analysis and optimization system, according to some embodiments;

FIG. 2 shows examples of the various phases of the user's golf swing captured for measurement, according to some embodiments;

FIG. 3 is a diagram of an exemplary process of predicting ball flight based on the user's swing, according to some embodiments;

FIG. 4 is a diagram of an exemplary deep learning process for swing optimization, according to some embodiments;

FIG. 5 is a diagram of an exemplary process for rendering an optimized swing, according to some embodiments; and

FIG. 6 is a diagram showing an exemplary process for developing a lesson based on the user's actual swing and optimized/desired swing, according to some embodiments.

### DETAILED DESCRIPTION

A system and method is provided for capturing time series data (e.g., using a camera, radar, LIDAR, etc.) of a user's golf swing, processing the time series data to measure features of the golfer's swing (e.g., wrist angle, shoulder angle, etc.), predicting the result of the user's swing (e.g., the shape of the ball trajectory, slice, fade, etc.), determining an optimized swing for the user based on the user's golf swing, and training the user to achieve the system generated optimized swing (e.g., including displaying the optimized swing over the user's current swing in real-time and/or by determining appropriate training material for the user). An optimized swing, as discussed further herein, includes one or more changes to the user's golf swing that are designed to adjust the user's current golf swing to achieve one or more objectives (e.g., less slice, less fade, etc., which can be specified by the user).

The inventors appreciated that traditional techniques used to learn how to golf and/or to improve a golf swing, including in-person lessons and/or trial-and-error training, suffer from numerous deficiencies as described above. The inventors have also discovered and appreciated that ball launch monitors and indoor simulators are more concerned with the trajectory of ball post-impact, rather than with determining the mechanics of the user's swing pre-impact. Therefore, launch monitors and/or simulators do not provide data about the user's swing or the correctness of the swing. Thus, just like existing techniques, launch monitors and simulators require a user to self-diagnose their own swing behavior and determine on their own what to change in order to improve their swing, which leads to inconsistent and often-times poor results.

The inventors have developed a golf analysis and training system that measures and models a user's golf swing motion and generates an optimized golf swing motion for the user to achieve. The optimized swing is customized for each user because it is based on the user's own unique swing and physical characteristics (e.g., age, size, golf handicap, etc.). The techniques use machine vision, signal processing, and deep learning techniques to measure the golfer's swing features and to analyze the key biomechanical attributes during the swing. The system determines needed change(s) to improve the user's swing and generates an optimized swing model to implement the needed change(s) that provides immediate feedback to the user, allowing the user to make adjustments to customize their swing to desired swing goals. The optimized swing model can reflect golf swing motion over time for the user to achieve, including the behavior of both the user and/or the golf club during the swing, that includes one or more changes to the user's golf swing motion to achieve the user's desired swing goals. The techniques can overlay the optimized swing features over a video of the user's swing in real-time so that a user can visually see how adjustments to the user's swing match (or do not match) to the optimal swing. The techniques can also include analyzing the user's swing compared to the optimized swing to determine a set of custom lessons for the user that the user can practice to achieve the determined optimal swing.

Examples of the methods, devices, and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

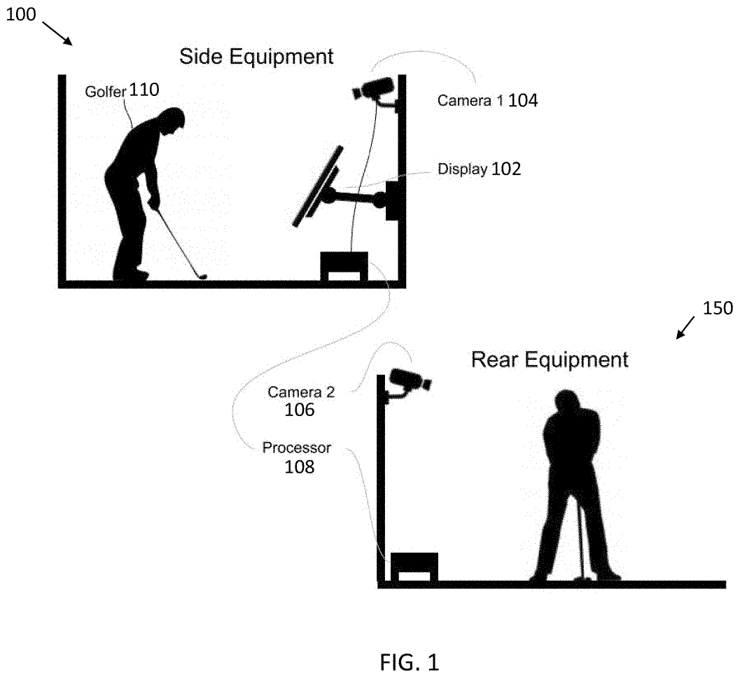

FIG. 1 shows diagrams 100 and 150, of a first view of side equipment and a second view of rear equipment of a golf swing analysis and optimization system, respectively, according to some embodiments. The diagrams 100 and 150 show the equipment, including a display 102, camera one 104, camera two 106 (referred to generally as cameras, herein), and a computing device 108 with a processor. The cameras and the display can be connected to the computing device. As described further herein, the system, using the equipment shown in diagrams 100 and 150, is configured to capture time series data (e.g., a video sequence) of the golfer 110, analyze and process the time series data sequence using the techniques described herein, and to interact with the user to provide them instruction. In some embodiments, the system can be deployed outdoors, such as at a driving range or golf instruction facility. In some embodiments, the system can be deployed indoors, such as at an indoor driving range or golf instruction facility. It should be appreciated that FIG. 1 shows exemplary components, and that other components can be used without departing from the techniques described herein. For example, instead of, or in addition to the cameras, other devices can be used to obtain the time series data, such as radar, LIDAR, and/or other systems capable of capturing time series data of the golfer's swing motion.

In some embodiments, stereo-vision camera systems can be used to implement the techniques described herein. For example, stereo-vision cameras can be used to generate three-dimensional data of the user's golf swing, such as depth maps and/or depth data. In some embodiments, the camera system can be comprised of a single, monocular camera and can be paired with a deep learning network to generate three-dimensional depth estimations from two-dimensional images. In some embodiments, the time series data (e.g., video) capturing techniques are configured to have a frame rate in order to capture sufficient information based on the golfer's swing speed. For example, for players with higher swing speeds (e.g., such as swings of players with lower handicaps), there is more club displacement, body displacement, etc. between successive frames compared to that of lower swings. Therefore, in some embodiments, high frame rate cameras can be configured for use in the system by synchronizing the exposure of the cameras to build a stereo-vision system for accurately capturing swing information at higher rates (e.g., which may not be available with existing stereo-vision techniques). While two cameras are shown, this is for illustrative purposes and it should be appreciated that any number of cameras can be used. For example, one camera may be used, three cameras may be used, and so on, as needed, to sufficiently capture aspects of the golfer's swing. As another example, different frame rate cameras can be used in the system. For example, one high frame rate camera (or radar, LIDAR, etc.) and one lower frame rate camera can be used in the system. In some embodiments, the high frame rate camera can be used to capture time series data of the user's swing, and the low frame rate camera can be used to capture the user's swing to overlay a resulting optimized swing model so that the user can practice the swing motion with the optimized swing model overlaid on actual image data of the user's swing, as described further herein.

In some embodiments, the computing device can be configured to perform the stereo-vision or mono-vision processing and/or swing processing using the techniques described herein. The computing device can be any computing device with sufficient processing capabilities to implement the techniques described herein. For example, NVIDIA's GPU devices, in conjunction with modern multi-core consumer CPUs, can be used as a compute platform to service the functionality described herein.

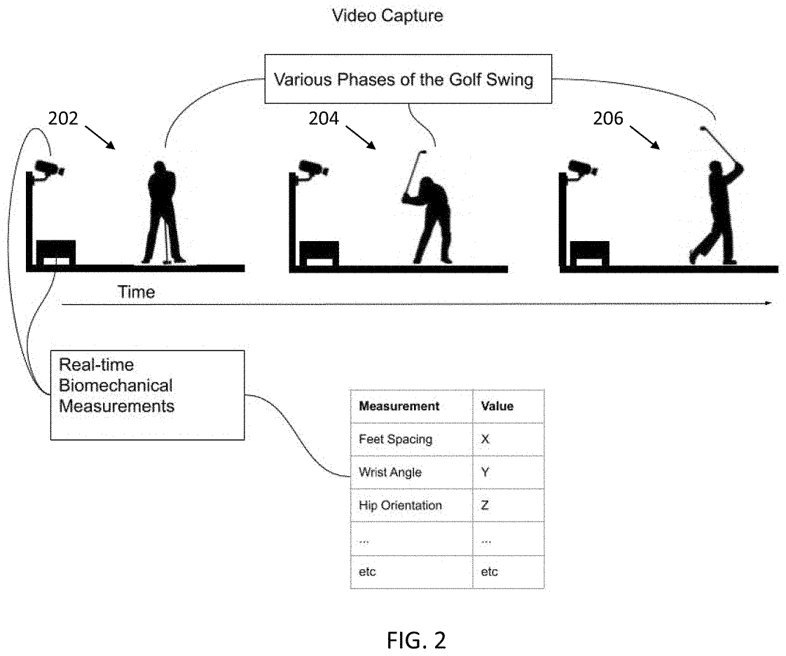

FIG. 2 shows the various phases of the user's golf swing captured for measurement, according to some embodiments. The techniques can subdivide the user's swing into various discrete phases, such as phases 202, 204 and 206, which are shown for exemplary purposes only, as any number of phases can be used. The computing device can measure and quantify various features of the user and the user's swing, such as positions of the user's body and club over time for each phase.

In some embodiments, the system can be configured to determine a relationship between each discrete phase of the golfer's swing to one or more frames from the time series data (e.g., video sequence) of the user's swing. Each frame of interest in the time series data can be used to measure aspects of the user's swing. For example, in some embodiments, the frames can be processed using object detection techniques. In some embodiments, the frames can be processed using a deep learning classifier (e.g., a Single Shot MultiBox Detector (SSD)-type region proposal network, a semantic segmenter, a pose estimator, and/or the like) to segment the golfer's body into various components. For example, the golfer's body can be segmented into forearms, wrists, upper leg, lower leg, knee, torso, shoulders, etc. The computing device can use machine vision techniques to quantify and measure spatial features of interest. Features of interest can include, for example, feet spacing, wrist angle, hip orientation, hip turn, elbow angle, etc.

Once all of the desired features have been measured on each frame of interest, the resultant measurements can be used to represent the golfer's swing as a discrete time series array of values. For example, if the techniques subdivide the swing into fifteen phases (e.g., represented using fifteen frames of video over the swing time of the player) then the system can perform pose estimation and collect positional estimation on various aspects of the player and their club for each frame. Therefore, for fifteen frames in an ordered sequence, the system can perform fifteen estimations for N features, and therefore the time-series array of values can be an array that is fifteen×N.

In some embodiments, pose estimation techniques can be used to measure the features. Pose estimation can include identifying the different features (e.g., using segmenting techniques, as described herein) to determine the pose of the features in a three-dimensional space. The pose estimation techniques can be extended to aspects of the golf club, including the club head, club shaft, etc., in addition to aspects of the golfer.

In some embodiments, instead of, or in addition to, using segmentation and pose estimation, aspects can be generated using single camera techniques. For example, three-dimensional estimation techniques that use a single camera can be used to determine the feature measurements. In some embodiments, multiple cameras can be used to capture aspects of the user's swing that may become occluded from a single camera as the user's body rotates through the golf swing. For example, two or more cameras (e.g., a side camera and a back camera) can be used to capture the user from various viewpoints so that while features may be occluded from one camera, they are visible to other camera(s).

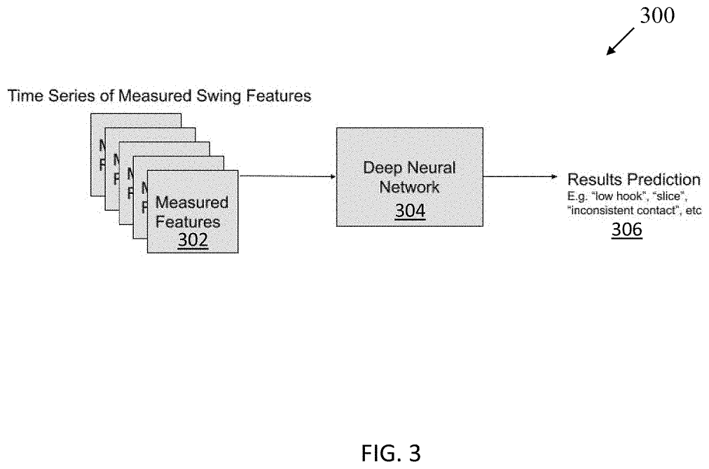

FIG. 3 shows a diagram of an exemplary process 300 of predicting ball flight based on the user's swing, according to some embodiments. As shown, the discrete time series measurement information 302 (e.g., which can be stored as a time-series array or other appropriate data structure) that represents the golfer's swing is processed using artificial intelligence techniques, shown as a deep neural network 304, to predict the resultant ball flight 306 (e.g., a low hook, slice, inconsistent contact, etc.). In this example, a behavior recognition network, such as Long Short-Term Memory (LSTM), Support-Vector Machine (SVM), Regions with Convolutional Neural Networks (R-CNN), multi-stream CNN, and/or the like, can be used to predict the ball flight. The behavior recognition network can be trained such that the network can use the input swing data to predict quantified ball flight characteristics, such as launch angle, speed, spin rate, etc., as well as qualitative derivatives, such as “hook”, “slice”, etc. Unlike traditional launch monitors, which are typically concerned only with the trajectory of the ball post-impact, the techniques described herein are focused on the user's swing motion (including the golf club) before and after impact with the ball.

The training data that is used to train the neural network can include data generated using the techniques described herein for various types of golf swings, different age groups, different size players, different handed players (e.g., left-handed players or right-handed players), etc. Recordings of the user's swing can be collected, translated into discrete time series values (e.g., using the techniques described herein), and then labeled with the ball flight data (e.g., the output ground truth). According to some embodiments, the techniques can use a plurality of data sets. For example, a first dataset can include labeled images captured of golfers during their swings. The labels can annotate the different segments of a person and their club. For example, an image of a golfer can have mask-style labels (e.g., left foot, right foot, left lower leg, right lower leg, right upper leg, left upper leg, waistline, left shoulder, right shoulder, left elbow, right elbow, left wrist, right wrist, head, club shaft, club head, and/or the like). This dataset can be used to train various machine learning models, such as semantic segmentation models, pose estimation models and/or instance segmentation models (e.g., such as U-Net, VideoPose3D, Faster R-CNN, etc.). For example, such machine learning models can be trained to take as an input an image of a golfer during their swing, segment their body into parts necessary for swing analysis, and return the position of these body components in the image plane (e.g., 2D (x, y) coordinates), the estimated real-world position (e.g., 3D (x, y, z) relative to the camera), or both. The generated positional data returned from one or more of these models can be used as an input for the next part of the processing pipeline (e.g., the deep neural network, as described herein).

As another example, a second dataset can map time-series features (e.g., position of body parts and club through time) of a golfer's swing to the ball-flight that resulted from that swing. For example, a golfer may be recorded by a high-fps camera while swinging and hitting a golf ball. This dataset will record the positional data of their body-parts (e.g., left foot, right foot, etc., as mentioned herein) and club throughout the swing as the input, and will have the ball-flight characteristics (launch angles, speed, spin) as the labels. This dataset can be used to train a sequence recognition/prediction network, such as an LSTM, as described herein.

In some embodiments, the techniques can use a plurality of neural networks, where each neural network is trained to analyze and/or predict an optimal swing for different types of users or groups of users. For example, different age groups may have different levels of flexibility. Therefore, the techniques can be designed to avoid determining an optimal swing for a person in the 40-50-year-old age bracket that the user cannot achieve, but instead could only likely be achieved by someone younger (e.g., someone in the 20-30-year-old age bracket). The techniques can include generating separate neural networks for different age groups (e.g., 15-20 years, 20-25 years, 25-30 years, 30-40 years, etc.). The neural networks can each be trained with data sufficient to train the neural network across the various swings likely to be exhibited by a user. For example, some and/or all swings, ranging from a complete snap hook to a complete slice, can be used to train the network.

As another example, different training information can be used for different handicaps. For example, users with a low handicap may exhibit similar swings, users with a medium handicap may also exhibit similar swings, and so on. Therefore, the neural networks can be trained to take into account different handicaps, and/or different neural networks can be trained for different handicaps.

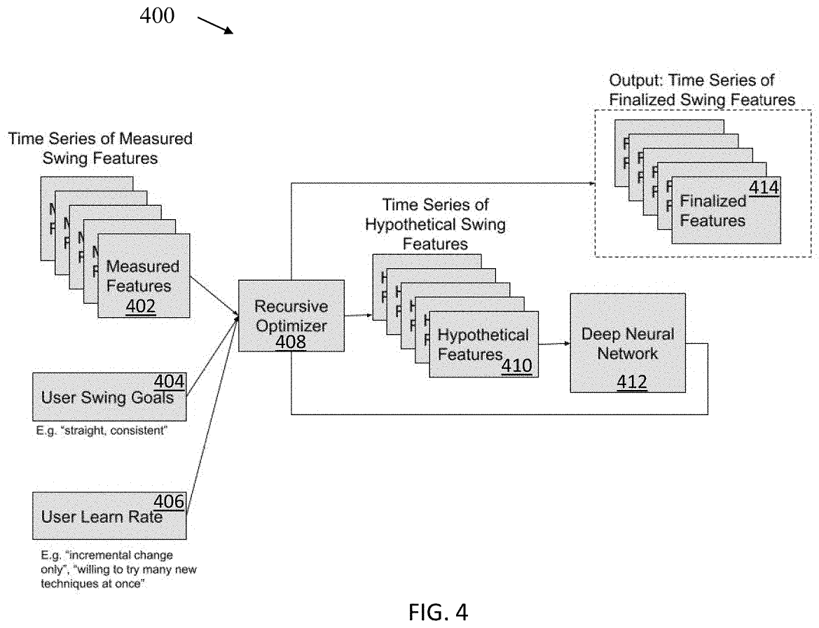

FIG. 4 shows diagram 400 of a deep learning process for swing optimization, according to some embodiments. As shown in the diagram 400, data of the user's actual golf swing 402 (e.g., determined using the techniques described herein), their swing goals 404 (e.g., to have a straight shot, to have a slight fade, to increase ball distance), and their desired learning rate 406 (e.g., work on one change of their swing at a time, or try many new techniques at once) can be processed to generate a new optimal swing for the user to learn, where the finalized features 414 are a modified version of the user's own swing.

In some embodiments, the optimal swing can be generated using a multivariable regression/optimization. As shown in FIG. 4, the user's measured swing features 402, user swing goals 404, and user learn rate 406 are processed using a recursive optimizer 408 that generates a time series of optimized swing features 410 (e.g., which include data similar to that generated as discussed in conjunction with FIG. 2) that are processed using a deep neural network 412 (e.g., the neural network discussed in conjunction with FIG. 3). The output of the deep neural network 412 can be recursively fed back into the recursive optimizer 408, which can repeat the process until the output of the neural network 412 generates an optimized swing that matches the user's swing goals. Once a set of features are achieved that match the user's swing goals, the system can be configured to output a time series of finalized swing features 414.

As an illustrative example, take a user that has a slice but desires a draw. After the user's time series data (e.g., a swing video) is captured and translated into a time series array of values (e.g., as discussed in conjunction with FIG. 2), the values can be manipulated and the output of the neural network may change. A regression/optimization algorithm, as shown, can perform iterative/recursive analysis, changing values throughout the input array until the neural network prediction is changed from slice to draw. Once the neural network output sufficiently indicates draw with a high confidence value, the final time series values for the swing can be finalized. These finalized time series values represent the modified version of the user's own swing for the user to learn.

In some embodiments, the processing to determine the finalized set of swing features can be constrained by setting achievable ranges for features of interest, such as for the user's spinal angle, shoulder rotation, shoulder axis, etc. For example, a user's spine angle will likely not be zero with respect to the X-axis, where the X-axis is parallel to the ground. As another example, the user's spine angle may have a different range of possible values for different frames/different phases of the swing. In some embodiments, upper and lower bounds for various features can be set, and the recursive optimization can be run across the possible space to determine which feature values at each discrete phase are likely to cause the shot shape desired by the user.

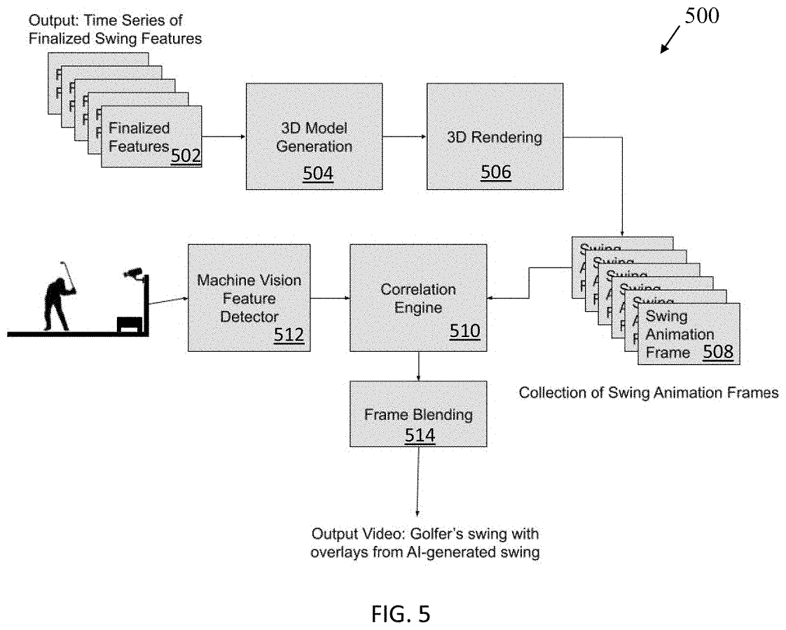

FIG. 5 shows a diagram of an exemplary process 500 for rendering an optimized swing, according to some embodiments. As shown in FIG. 5, the finalized features 502 (e.g., the finalized features 414 determined in FIG. 4) are processed by a 3D model generation unit 502 to generate a 3D model of the optimal swing. The 3D model of the optimal swing is rendered using the 3D rendering unit 506 into a series of animation frames 508. A feature detector 512 (e.g., which uses machine vision techniques) detects features of the golfer as the golfer swings (e.g., in real-time, during the golfers swing), which generates a set of segmented data (e.g., segmented frames). The correlation engine 510 (e.g., in real-time during the user's swing) correlates the segmented data with the swing animation frames 508 and the frame blending unit 514 blends and/or overlays the swing animation frames 508 onto the segmented data of the golfer to generate a video of the golfer's swing with the overlays. The output video can be displayed to the user while the user swings (e.g., via the display shown in FIG. 1). The real-time augmentation of the video of the user's swing with the optimal swing can help the golfer visualize the correct swing mechanics and positions (and modifications to the user's current swing). The system can be designed such that the golfer can swing at any speed (e.g., swing slowly and deliberately, normally, pause their swing, etc.), and the overlay/blend of the optimized swing aspects are in sync with the phase of their swing. The same devices (e.g., cameras) and/or different devices used to capture time series data of the user's golf swing motion for analysis can be used to capture segmented data of the golfer for blending. For example, in some embodiments, a low-speed camera can be used to capture video frames of the user so that the user can see a video of themselves with the overlaid swing animation data.

In some embodiments, to facilitate real-time and synchronized overlay/blending with the golfer's swing phase, the feature detector 512 processes the time series data of the golfer and segments the golfer's body into components (e.g., wrists, arms, legs, etc.). The feature detector 512 can use, for example, the techniques discussed above with respect to FIG. 2 (e.g., such as SSD region proposal network or semantic segmentation neural networks). The correlation engine 510 can determine which animation frame from the generated collection of frames 508 most closely matches the current state of the golfer's swing. The correlation engine 510 can pass the current frame of the golfer's swing and the closest matching animation frame to the blending/overlaying engine 524 to generate the output video of the user's swing being displayed back to the user as a composite with appropriate the swing animation frame 508.

In some embodiments, the composite output of the animation frame blended/overlaid with the real golfer's frame can be viewed by the golfer using an AR headset. For example, the golfer could wear an AR headset while swinging, and the visuals rendered on their headset would be the animation frames overlaying on their body from the first-person perspective.

In some embodiments, the blending engine 514 can color code the blended pixels based on the positional correctness of the real golfer's video frames to the animated frames. For example, if the golfer's forearm is in the correct position at a particular phase in the swing, the pixels in the overlay/blend that match the forearm could be displayed in green (or shaded green) so that the user knows that part of the user's swing mechanics do not need to be adjusted. If, for example, the user's wrists are in an incorrect position, the pixels of the user's wrist could be shown (or shaded) in varying degrees of yellow or red, depending on the severity of the incorrect position. Using a color code and spectrum as an indication of correctness can help the golfer easily pinpoint the most correct or incorrect aspects of their swing at any phase.

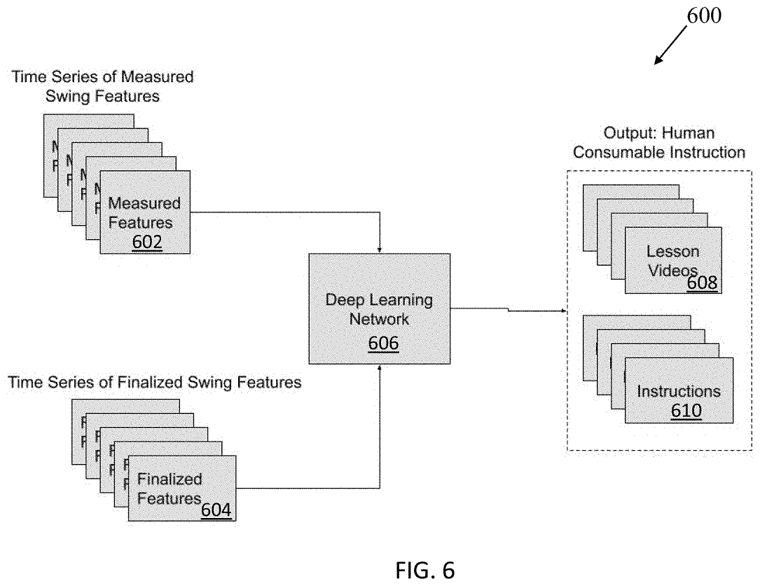

FIG. 6 is a diagram showing an example 600 of developing a lesson based on the user's actual swing and system generated optimized swing, according to some embodiments. The time series of the user's measured features 602 (of the user's actual swing) and the time series of the optimized features 604 (the user's optimized swing) are processed by a deep learning network 606 to determine one or more lesson videos 608 and/or instructions 610 that are tailored towards improving the one or more problems with the user's swing. For example, assume a user has a draw but desires a fade. After the system generates an optimized, corrected swing for the user, the user may desire to have lessons and/or instruction to internalize and retain this new swing. The deep learning network can take the user's actual swing features 602, their optimized swing features 604, compare the two, and identify specific videos 608 and/or instructions 610 for the user to practice. The network can be trained to recognize differences between the actual swing features 602 and optimized swing features 604, and use those differences to determine the appropriate instruction for the user.

Techniques operating according to the principles described herein may be implemented in any suitable manner. The processing and decision blocks of the flow charts above represent steps and acts that may be included in algorithms that carry out these various processes. Algorithms derived from these processes may be implemented as software integrated with and directing the operation of one or more single- or multi-purpose processors, may be implemented as functionally-equivalent circuits such as a Digital Signal Processing (DSP) circuit or an Application-Specific Integrated Circuit (ASIC), or may be implemented in any other suitable manner. It should be appreciated that the flow charts included herein do not depict the syntax or operation of any particular circuit or of any particular programming language or type of programming language. Rather, the flow charts illustrate the functional information one skilled in the art may use to fabricate circuits or to implement computer software algorithms to perform the processing of a particular apparatus carrying out the types of techniques described herein. It should also be appreciated that, unless otherwise indicated herein, the particular sequence of steps and/or acts described in each flow chart is merely illustrative of the algorithms that may be implemented and can be varied in implementations and embodiments of the principles described herein.

Accordingly, in some embodiments, the techniques described herein may be embodied in computer-executable instructions implemented as software, including application software, system software, firmware, middleware, embedded code, or any other suitable type of computer code. Such computer-executable instructions may be written using any of a number of suitable programming languages and/or programming or scripting tools, and also may be compiled as executable machine language code or intermediate code that is executed on a framework or virtual machine.

When techniques described herein are embodied as computer-executable instructions, these computer-executable instructions may be implemented in any suitable manner, including as a number of functional facilities, each providing one or more operations to complete the execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application.

Some exemplary functional facilities have been described herein for carrying out one or more tasks. It should be appreciated, though, that the functional facilities and division of tasks described are merely illustrative of the type of functional facilities that may implement the exemplary techniques described herein, and that embodiments are not limited to being implemented in any specific number, division, or type of functional facilities. In some implementations, all functionality may be implemented in a single functional facility. It should also be appreciated that, in some implementations, some of the functional facilities described herein may be implemented together with or separately from others (i.e., as a single unit or separate units), or some of these functional facilities may not be implemented.

Computer-executable instructions implementing the techniques described herein (when implemented as one or more functional facilities or in any other manner) may, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium may be implemented in any suitable manner. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium may be altered during a recording process.

Further, some techniques described above comprise acts of storing information (e.g., data and/or instructions) in certain ways for use by these techniques. In some implementations of these techniques—such as implementations where the techniques are implemented as computer-executable instructions—the information may be encoded on a computer-readable storage media. Where specific structures are described herein as advantageous formats in which to store this information, these structures may be used to impart a physical organization of the information when encoded on the storage medium. These advantageous structures may then provide functionality to the storage medium by affecting operations of one or more processors interacting with the information; for example, by increasing the efficiency of computer operations performed by the processor(s).

In some, but not all, implementations in which the techniques may be embodied as computer-executable instructions, these instructions may be executed on one or more suitable computing device(s) operating in any suitable computer system, or one or more computing devices (or one or more processors of one or more computing devices) may be programmed to execute the computer-executable instructions. A computing device or processor may be programmed to execute instructions when the instructions are stored in a manner accessible to the computing device or processor, such as in a data store (e.g., an on-chip cache or instruction register, a computer-readable storage medium accessible via a bus, a computer-readable storage medium accessible via one or more networks and accessible by the device/processor, etc.). Functional facilities comprising these computer-executable instructions may be integrated with and direct the operation of a single multi-purpose programmable digital computing device, a coordinated system of two or more multi-purpose computing device sharing processing power and jointly carrying out the techniques described herein, a single computing device or coordinated system of computing device (co-located or geographically distributed) dedicated to executing the techniques described herein, one or more Field-Programmable Gate Arrays (FPGAs) for carrying out the techniques described herein, or any other suitable system.

A computing device may comprise at least one processor, a network adapter, and computer-readable storage media. A computing device may be, for example, a desktop or laptop personal computer, a personal digital assistant (PDA), a smart mobile phone, a server, or any other suitable computing device. A network adapter may be any suitable hardware and/or software to enable the computing device to communicate wired and/or wirelessly with any other suitable computing device over any suitable computing network. The computing network may include wireless access points, switches, routers, gateways, and/or other networking equipment as well as any suitable wired and/or wireless communication medium or media for exchanging data between two or more computers, including the Internet. Computer-readable media may be adapted to store data to be processed and/or instructions to be executed by processor. The processor enables processing of data and execution of instructions. The data and instructions may be stored on the computer-readable storage media.

A computing device may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Embodiments have been described where the techniques are implemented in circuitry and/or computer-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

1. A system comprising a memory storing instructions, and a processor configured to execute the instructions to perform:
receiving preference data indicative of a user's desired golf ball flight;
capturing time series data of the user while performing a golf swing;
processing the time series data to generate a time series array of positional values of one or more aspects of the golfer, aspects of the golf club, or both;
processing the time series array using a machine learning model to determine data indicative of a predicted ball flight for the captured golf swing;
generating, based on the time series array and the data indicative of the predicted ball flight, data indicative of one or more modifications to the user's golf swing to achieve the desired ball flight instead of the predicted ball flight;
generating, based on the data indicative of one or more modifications to the user's golf swing, data indicative of a recommended golf swing for the user to achieve the desired golf ball flight; and
generate display data indicative of the recommended golf swing overlaid on second captured time series data of the user performing a second golf swing.

2. The system of claim 1, wherein processing the time series data to generate the time series array of positional values comprises:
processing the time series data using a second machine learning model to determine the position of one or more body components, one or more golf club components, or both.

3. The system of claim 2, further comprising:
training the second machine learning model using a training dataset comprising a set of labeled images captured of golfers while performing golf swings, wherein the labels of each of the labeled images annotate a position of one or more of the associated golfer's one or more body components, one or more golf club components, or both.

4. The system of claim 2, wherein:
the one or more body components comprise a left foot, right foot, left lower leg, right lower leg, right upper leg, left upper leg, waistline, left shoulder, right shoulder, left elbow, right elbow, left wrist, right wrist, head, or some combination thereof; and
the one or more golf club components comprise a club shaft, club head, or some combination thereof.

5. The system of claim 1, further comprising training the machine learning model using a training dataset to train the machine learning model to map the time series array to the predicted ball flight, wherein the training dataset comprises a plurality of sets of time series data of test users performing a test golf swing and labels comprising associated ball flight characteristics.

6. The system of claim 1, wherein displaying the data indicative of the recommended golf swing overlaid on second captured time series data of the user comprises:
generating a 3D model of the recommended golf swing, comprising a series of swing animation frames;
detecting, based on the second captured time series data, a second time series array of the user as the user performs the second golf swing;
correlating the second time series array with the series of swing animation frames to overlay the swing animation frames onto the second time series array to generate a video of the user's second swing with the overlaid swing animation frames.

7. A computerized method, comprising:
receiving preference data indicative of a user's desired golf ball flight;
capturing time series data of the user while performing a golf swing;
processing the time series data to generate a time series array of positional values of one or more aspects of the golfer, aspects of the golf club, or both;
processing the time series array using a machine learning model to determine data indicative of a predicted ball flight for the captured golf swing;
generating, based on the time series array and the data indicative of the predicted ball flight, data indicative of one or more modifications to the user's golf swing to achieve the desired ball flight instead of the predicted ball flight;
generating, based on the data indicative of one or more modifications to the user's golf swing, data indicative of a recommended golf swing for the user to achieve the desired golf ball flight; and
generate display data indicative of the recommended golf swing overlaid on second captured time series data of the user performing a second golf swing.

8. A non-transitory computer-readable media comprising instructions that, when executed by one or more processors on a computing device, are operable to cause the one or more processors to perform:
receiving preference data indicative of a user's desired golf ball flight;
capturing time series data of the user while performing a golf swing;
processing the time series data to generate a time series array of positional values of one or more aspects of the golfer, aspects of the golf club, or both;
processing the time series array using a machine learning model to determine data indicative of a predicted ball flight for the captured golf swing;
generating, based on the time series array and the data indicative of the predicted ball flight, data indicative of one or more modifications to the user's golf swing to achieve the desired ball flight instead of the predicted ball flight;
generating, based on the data indicative of one or more modifications to the user's golf swing, data indicative of a recommended golf swing for the user to achieve the desired golf ball flight; and
generate display data indicative of the recommended golf swing overlaid on second captured time series data of the user performing a second golf swing.
